(19) United States
(12) Patent Application Publication
(10) Pub. No.: US 2014/0204459 A1
(43) Pub. Date: Jul. 24, 2014

(54) HIGH EFFICIENCY LIGHT COMBINATION MODULE OF PROJECTION SYSTEM

(71) Applicants: Ho Lu, (US); CYNOSURE PHOTONICS CORP., Hsinchu County (TW)

(72) Inventor: Ho Lu, Hsinchu County (TW)

(73) Assignees: CYNOSURE PHOTONICS CORP., Hsinchu County (TW); Ho Lu, Hsinchu County (TW)

(21) Appl. No.: 13/747,432

(22) Filed: Jan. 22, 2013

(51) Int. Cl. G02B 27/28

(52) U.S. Cl. CPC G02B 27/283
USPC 359/487.04; 359/489.09

(57) ABSTRACT

A high efficiency light combination module of projection system includes a cubic polarizing beam splitter prism serving as a main body around which four lens arrays, three retarders, and three optical plates are arranged, which is used in combination with coatings that enables transmission or reflection of specific lights to allow different color lights incident from different directions to be combined as a single illumination light beam and to allow the single illumination light beam so combined to be uniform by the lens arrays to facilitate light collection and projection by a panel and a projection lens arranged behind. A polarization conversion film is set at light outgoing port to transfer the polarization states of the combined single illumination light beam into a specific polarized light for a liquid crystal projection system.

### (A) TECHNICAL FIELD OF THE INVENTION

The present invention generally relates to a high efficiency light combination module of projection system, and more particularly to a multifunctional module that receives multiple color lights and projects a light beam with improved brightness and uniformity and is applicable to a stand-alone or an embedded projection system in addition to applications to a projection system that is externally connected to (or built in) a mobile phone, a camera, a video recorder, a notebook or tablet computer.

### (B) DESCRIPTION OF THE PRIOR ART

A major shortcoming of a regular micro-projection system is insufficiency of brightness (due to excessive optic loss). The precision and cost of manufacturing are the other important issues to be considered in addition. To provide an excellent micro-projection system, it is necessary to find a good design that is easy to manufacture, has reduced cost and optical loss, and is applicable to both a stand-alone system and being built in (or externally connected to) a digital electronic product.

To handle the issue of insufficient brightness in conventional micro-projection systems, a common solution is illustrated in FIG. 12, which is a schematic view illustrating a color light combination device used in a conventional projection system, comprising a X-cube prism 91 and three light source modules 90. The X-cube prism 91 has four sides and an X-shaped coating film 92 is formed by extending diagonal directions and intersecting each other. The X-shaped coating film 92 features reflection or transmission of red, green, or blue light.

The three light source modules 90 are set at three sides of the X-cube prism 91 respectively and each of the light source modules 90 comprises a light-emitting diode (which is either red (R), green (G), or blue (B) LED source) and a collimation lens. When lights being emitted from the LED sources of the three light source modules 90 (R, G, B) are collimated and projected to the X-cube prism 91, the lights are processed by the X-shaped coating film 92 to project out through a light outgoing side of the X-cube prism 91 (as indicated by the arrows on the lower side of FIG. 12). Such an arrangement has the following disadvantages:

Firstly, the X-shaped coating film is of an intersecting arrangement, which makes incident angles as 45 degrees. The large incident angles induce some loss of transmittance or reflectance at the wavebands between color intersections of the LED sources. As shown in FIG. 13, due to the coating characteristics of polarization and large angle incidence, P polarization curve and S polarization curve in the spectrum are separated seriously and this leads to cut off a portion of light in the emission bands between the separated P and S curves, such as the region C and region Y, causing loss (total 20% loss probably). The loss is most severe for systems that uses wideband green light source (as shown in FIG. 11, in which the green light source is generated by excitation of fluorescent powder by blue LED). This leads to insufficient brightness and waste of energy and is one of the major shortcomings.

Furthermore, because of the dimensional limit, conventional micro-projection systems usually function for light combination (or light uniformity in addition) but do not include the function of polarization conversion which is able to transfer a non-polarized light to a single polarized state of light. Consequently, one half of light cannot be used in a liquid crystal based micro-projection system which can be operated under a single polarized state of light only. This leads to a loss of light and insufficient brightness. This is another shortcoming of the prior art technology

### SUMMARY OF THE INVENTION

An object of the present invention is to provide a high efficiency light combination module of projection system that overcomes the above discussed problems.

The present invention provides a high efficiency light combination module of projection system, which at least comprises: a primary prism, which is a cubic prism having three sides serving as light incidence or light reflection, a remaining side serving as an outgoing side for light projection, a polarizing beam splitter film being set along a diagonal section between two opposite corner roofs of the primary prism; four lens arrays, which each comprises a number of lens units and are arranged at the sides of the primary prism respectively; three retarders, which are respectively set at the said three sides, serving as light incidence or light reflection, of the primary prism relative to the lens arrays at each side to switch P and S polarization states of light; and three optical plates, which are set outside the three retarders and the lens arrays respectively, each of the three optical plates having one side coating for transmitting or reflecting the specific lights.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a view showing an assembled structure.

FIG. 2 is an exploded view.

FIG. 2A is an exploded view showing another embodiment.

FIG. 3 is a schematic view of light projection, showing an application of the present invention, wherein a color light (such as green) is incident from left side (of the drawings sheet).

FIG. 4 is a schematic view of light projection, showing an application of the present invention, wherein the other two color lights (such as red and blue) are incident from top side (of the drawings sheet).

FIG. 5 is a schematic view of light projection, showing a color light (such as green) incident from left side (of the drawings sheet).

FIG. 6 is a schematic view of light projection, showing the other two color lights (such as red and blue) incident from top side (of the drawings sheet).

FIG. 7 is schematic view of variation of light projection, showing two color lights (such as red and blue) incident from top side (of the drawings sheet).

FIG. 8 shows a first example of application of the present invention.

FIG. 9 shows a second example of application of the present invention.

FIG. 10 is a schematic view showing a primary prism that is formed by integrating unit prisms with lens arrays.

FIG. 11 is a plot of spectrum of light used in the present invention.

FIG. 12 is a schematic view showing a conventional projection structure.

FIG. 13 is a plot showing spectrum curves shifting of P and S occurring in a beams splitter coating film for large angle incidence of the known prior art.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

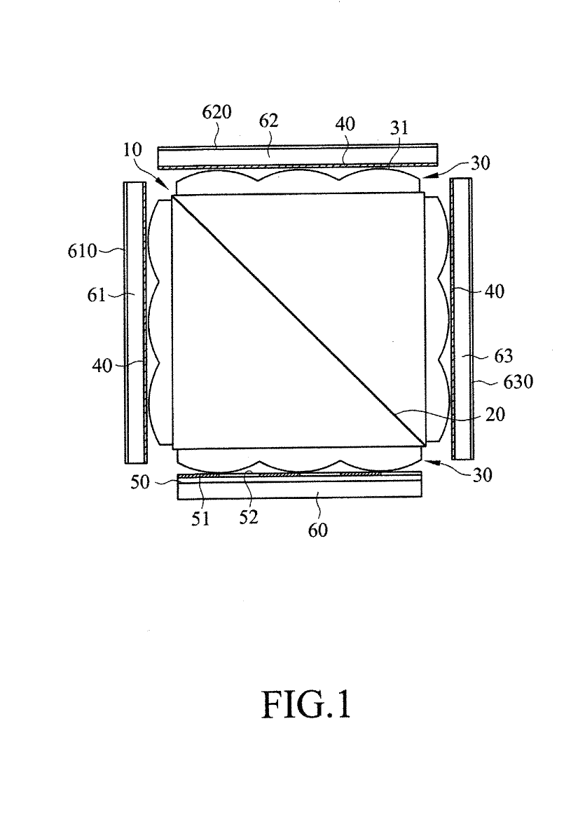

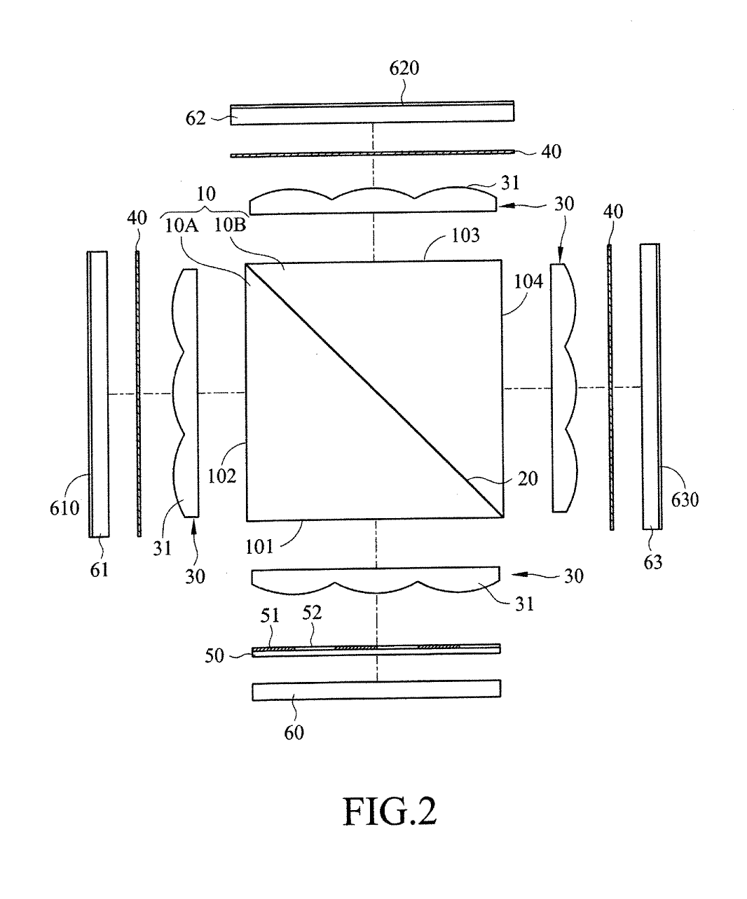

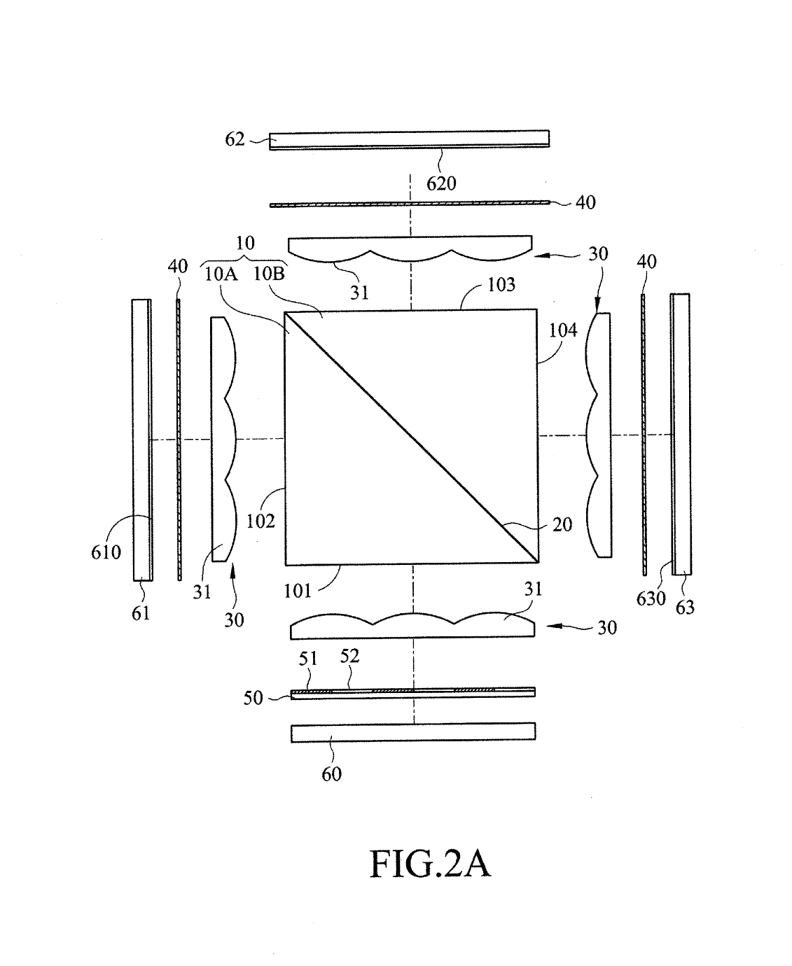

Referring to FIGS. 1 and 2, the present invention comprises at least:

A primary prism 10, which is a cubic prism, has three sides serving as light incidence or light reflection, which are sides 102, 103, 104, and a remaining side serving as light projection, which is an outgoing side 101. A polarizing beam splitter 20 (PBS) is set along a diagonal section between two opposite corner roofs of the primary prism 10. To make manufacturing easy, as shown in FIG. 2, the primary prism 10 can be formed by composing two unit prisms 10A, 10B glued to each other, which are in the form of right angle prisms.

Four lens arrays 30 are set at the sides 101, 102, 103, 104 of the primary prism 10 respectively and each comprises a number of lens units 31. The lens arrays 30 are arranged to have flat sides thereof adjacent to the sides 101, 102, 103, 104 of the prism 10 as shown in FIG. 2 or alternatively, the curved sides of the lens units 31 are set adjacent to the sides 101, 102, 103, 104 of the prism 10 as shown in FIG. 2A.

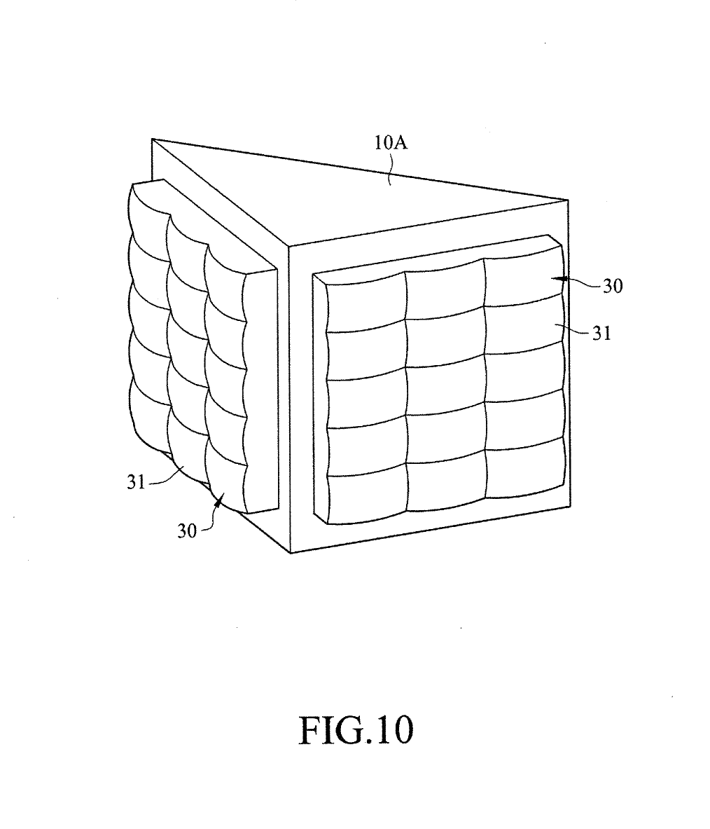

When the four lens arrays 30 are set to have the flat sides thereof adjacent to the sides 101, 102, 103, 104 of the prism 10 as shown in FIG. 2, for simplifying assembly, as shown in FIG. 10, the unit prisms 10A, 10B of the primary prism 10 can be each combined with two lens arrays 30 through injection or molding. Then, as shown in FIG. 2, the two unit prisms 10A, 10B that are combined with the lens arrays 30 are provided with the polarizing beam splitter 20 therebetween and are bonded together with the inclined surfaces thereof to thereby form a core component of the present invention.

Referring to FIGS. 1 and 2, three retarders 40 are respectively set at the three sides 102, 103, 104 of the primary prism 10 that serve as the light incidence or light reflection relative to the lens arrays 30. The retarders 40 function to interchange P and S polarization states of the polarized lights which are traveling back and forth through the lens arrays 30 at the three sides 102, 103, 104 of the primary prism 10. Actually, the positions of the retarders 40 and the lens array 30 can interchanged with each other in the embodiments shown in FIGS. 1, 2, and 2A, without causing influence on the operation thereof.

The retarders 40 can be formed of quarter wave plate retarders or equivalent optical films to change the polarization characteristics of transmitting light. Detailed operation and orient alignment condition between phase retardation axis and the field direction of the polarized light are well known to those having ordinary skill in the art so that detailed descriptions thereof will be omitted.

Three optical plates 61, 62, 63 are respectively set outside the three retarders 40 and the associated lens array 30. The three optical plates 61, 62, 63 each have a side on which a coating 610, 620, 630 is formed to allow a specific light to transmit or reflect. Or alternatively, one of the optical plates (such as the right-side optical plate 63 of FIGS. 1 and 2) is arranged to have entire reflection coating (such as layer 630 of FIGS. 1 and 2) serving as mirror surfaces of. The coatings 610, 620, 630 can be formed of a coated film or an attached film.

For safety or other reasons, the primary prism 20 or the optical plates 61, 62, 63 are chamfered or the corners thereof are made rounded. Modification of this sort can be adopted provided propagation of light is not affected.

The above arrangement provides a novel and effective multifunction light combination module for projection system. For further explanation of practical application of the present invention, a description will be given to the arrangement of the coatings 610, 620, 630 for transmission or reflection of specific light and handling of the polarized light as follow.

As shown in FIGS. 1 and 2, the coating 610 of the left-side optical plate 61 are reflective to red light and blue light and transmissive to green light; the coating 620 of the top-side optical plate 62 is reflective to green light and transmissive to red light and blue light; and the side of the right-side optical plate 63 is provided with a mirror surface of entire reflection coating 630.

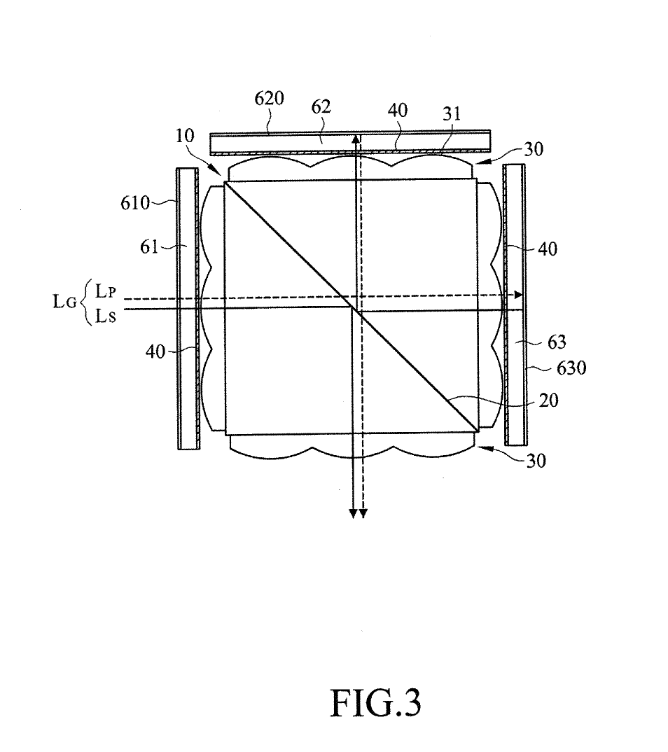

Referring to FIG. 3, a collimated green light L_{G} is incident normally to an outer side of the optical plate 61 (the left-hand side of the drawing sheet) and transmits through the green light transmissive coating 610 to sequentially pass through the optical plate 61, the retarder 40, and the lens array 30 to impinge the polarizing beam splitter 20 of the primary prism 10, wherein the S polarized light L_{S} (indicated by solid line, this being also applied hereinafter) of the green light L_{G} encounters the polarizing beam splitter 20 and is reflected to the outgoing side 101 of the primary prism 10 to travel through the lens array 30 for outward emission. The P polarized light L_{P} (indicated by dotted line, this being also applied hereinafter) of the green light L_{G} transmits through the polarizing beam splitter 20, passing through the lens array 30 to encounter the right-side retarder 40 and the optical plate 63 located behind, whereby the coating 630 on the side of the optical plate 63 reflects the green light and converts, through the characteristics of the retarder 40, the original polarized light into S polarized light L_{S} (solid line) to be directed to the polarizing beam splitter 20 to be reflected thereby in an upward direction to pass through the lens array 30, the retarder 40, and the optical plate 62 at that side and reflected by the coating 620 on the side of the optical plate 62 and converted, through the characteristics of the retarder 40, from the original polarized light into P polarized light L_{P} (dotted line) to be directed toward and through the polarizing beam splitter 20 and pass through the outgoing side 101 of the primary prism 10 for outward emission through the lens array 30.

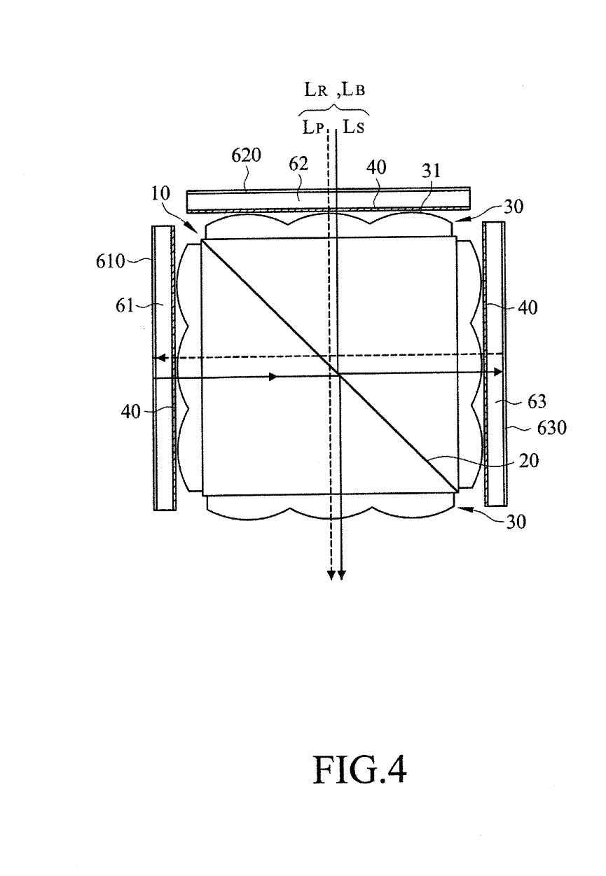

As shown in FIG. 4, collimated red light L_{R} and blue light L_{B} are both incident normally to an outer side of the optical plate 62 (the top side of the drawing sheet) and transmit through the red and blue light transmissive coating 620 to sequentially pass through the optical plate 62, the retarder 40, and the lens array 30 to impinge the polarizing beam splitter 20 at the center of the primary prism 10, wherein the P polarized lights L_{P} (indicated by dotted line) of the red light L_{R} and the blue light L_{B} transmit through the polarizing beam splitter 20 and pass through the outgoing side 101 of the primary prism 10 for outward emission through the lens array 30. The S polarized light L_{S} (indicated by solid line) of the red light L_{R} and the blue light L_{B} encounter the polarizing beam splitter 20 and are reflected to the right side to pass through the lens array 30 and encounter the right-side retarder 40 and the optical plate 63 located behind, whereby the coating 630 on the outer side of the optical plate 63 reflects the red and blue lights and converts, through the characteristics of the retarder 40, the original polarized light into P polarized light L_{P} (dotted line) to be directed toward and through the polarizing beam splitter 20 to encounter the left-side lens array 30, the retarder 40, and the optical plate 61 located behind, whereby the coating 610 at the outer side of the optical plate 61 also reflects the red and blue lights and converts, through the characteristics of the retarder 40, the original polarized light into S polarized light L_{S} (solid line) to be directed to the polarizing beam splitter 20 to be reflected to the outgoing side 101 of the primary prism 10 to pass through the lens array 30 for outward emission.

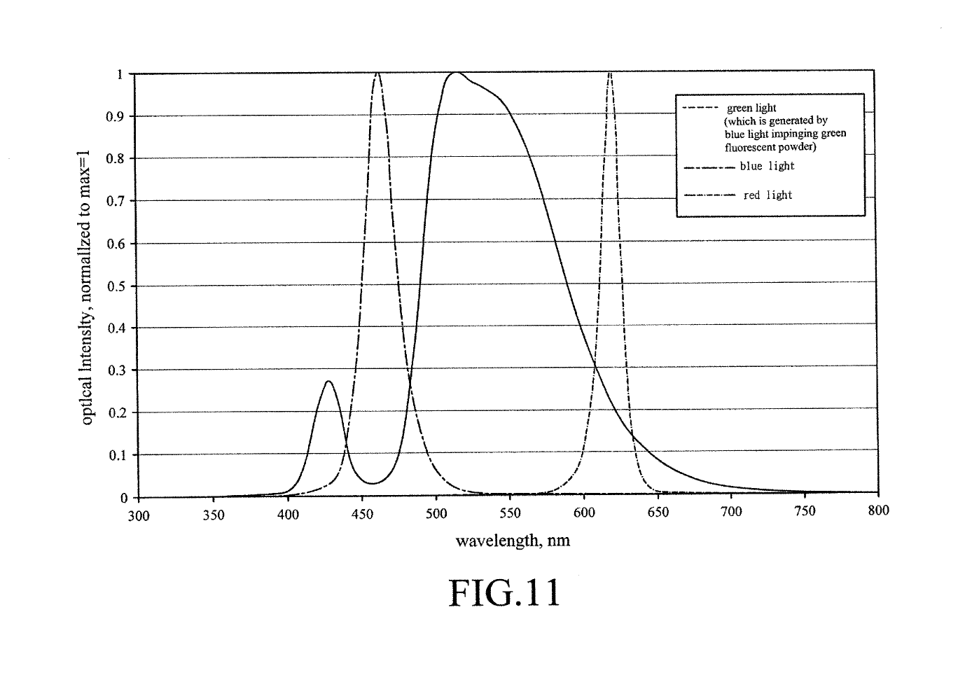

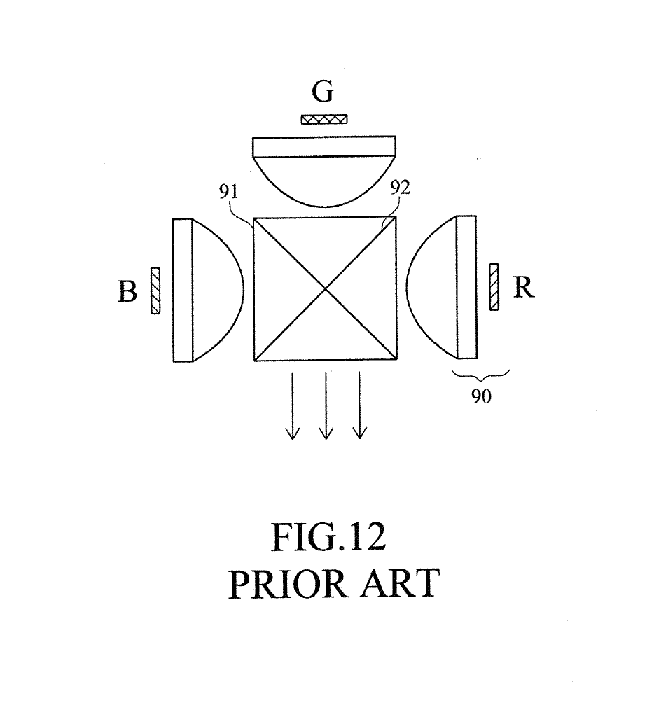

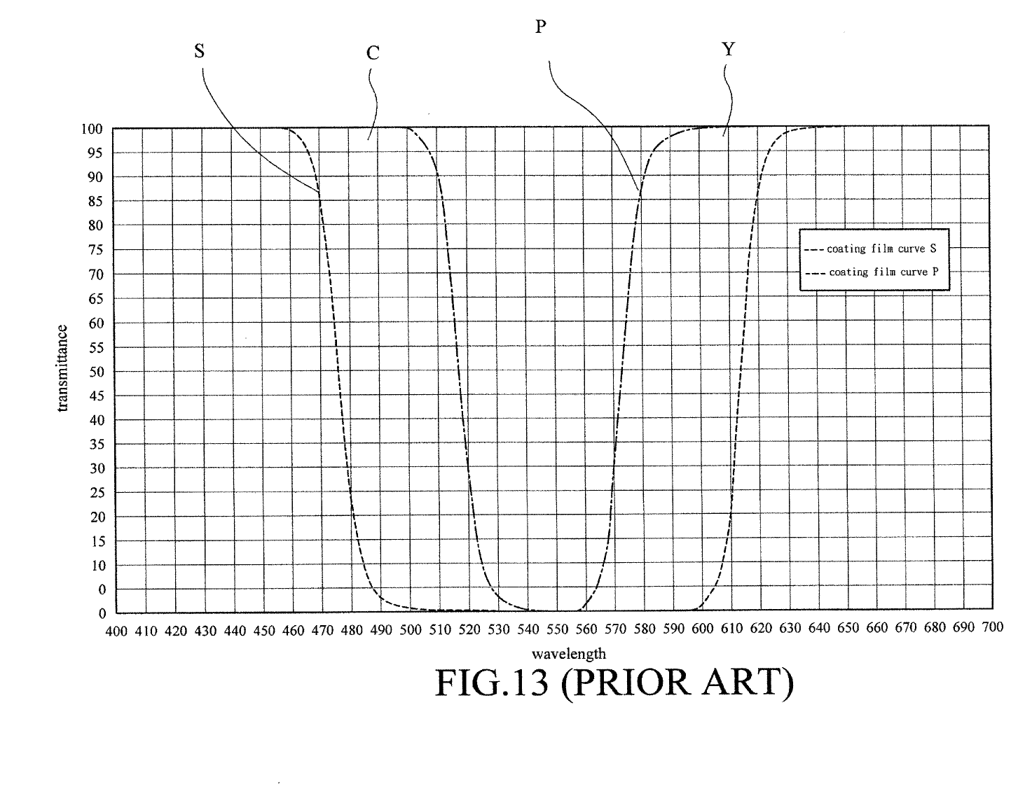

The present invention uses a polarizing beam splitter 20 as a core of the light combination system to replace the conventional way of light combination through X-shaped coating 92 (see FIG. 12). Since light is incident normally to the light-splitting coatings 610, 620, 630, the problem of energy loss disappears in light combination process, that is caused by spectrum curve shifting of P and S polarized lights (see FIG. 13) due to large angle (such as 45 degrees) incidence onto the conventional splitter in the known technology. The arrangement of the present invention is most effective to wideband green LED light (as shown in FIG. 11, in which the green light source is generated by excitation of fluorescent powder by blue LED).

Further, the present invention arranges lens arrays 30 as the circumference of the primary prism 10 shown in FIGS. 1, 2, 3, and 4 and arranges the lens units 31 of the lens arrays 30 in such a way to divide an incident beam into a number of small-range sub-beams. The corresponding lens units of each lens array allow the respective sub-beams to travel reciprocally between the primary prism, each retarder 40 and each optical plate 61, 62, 63 without expansions. Thus, expansion of size and energy loss (due to etendue enlargement from beam expansion) can be avoided during the process of light combination and in addition, uniformity of emitting light beam can also be achieved by the functions of lens arrays.

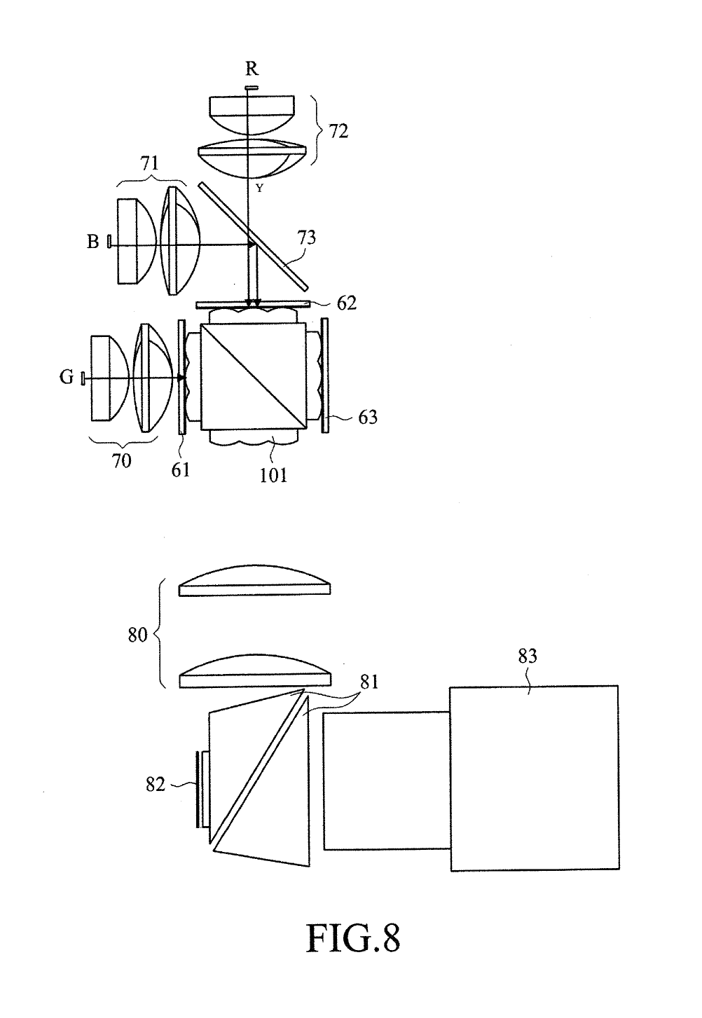

Referring to FIGS. 3 and 4, an example of disposition of the green light L_{G}, the red light L_{R}, and the blue light L_{B} is given. Reference is also made to FIGS. 2 and 8, a green light collimating lens module 70 is set at a light incidence port 102 of the primary prism 10 to guide a single color and collimated light to get incident normally to the optical plate 61. An adjacent light incidence port 103 is provided with a blue light collimating lens module 71 and a red light collimating lens module 72, and a color beam splitter 73 is also included to guide red and blue collimated lights to get incident normally onto the optical plate 62. In addition, a condenser lens set 80 and a total internal reflection (TIR) prism set 81 are arranged at the outgoing side 101 of the primary prism 10 to guide the combined uniform light beam toward a panel 82, which is a digital light processing (DLP™) imager, and image carried by the panel is projected through a projection lens 83.

The operations of the condenser lens set 80, the beam splitter, the TIR prism set 81, DLP™ panel 82, and the projection lens 83 are all well known arts and further details are omitted herein.

Referring to FIGS. 1 and 2, a polarization conversion film 50 is additionally arranged at the outgoing side 101 of the primary prism 10 at a location corresponding to the lens array 30 of this site. The polarization conversion film 50 has a surface on which interlaced retarder stripes are formed to constitute polarization conversion zones 51 having property of phase retardation and non-operative light transmission zones 52. The polarization conversion zones 51 and the light transmission zones 52 both take half of the surface area of each lens unit 31 of the lens array 30 (see FIG. 2). The retarder stripes of the polarization conversion zones 51 have the property of half-wave plate with 45 degrees or 135 degrees phase retardation axis relative to the polarization axis of the polarized light. The half wave phase retardation characteristics and the axis arrangement of the polarization conversion zones 51 allow the incident polarized lights L_{S}, L_{P} to switch with respect to the polarization thereof.

The purposes of adding a polarization conversion film 50 at the outgoing side 101 of the primary prism 10 is to convert the emitting light into a specific polarized light, making it fit for liquid crystal projection systems.

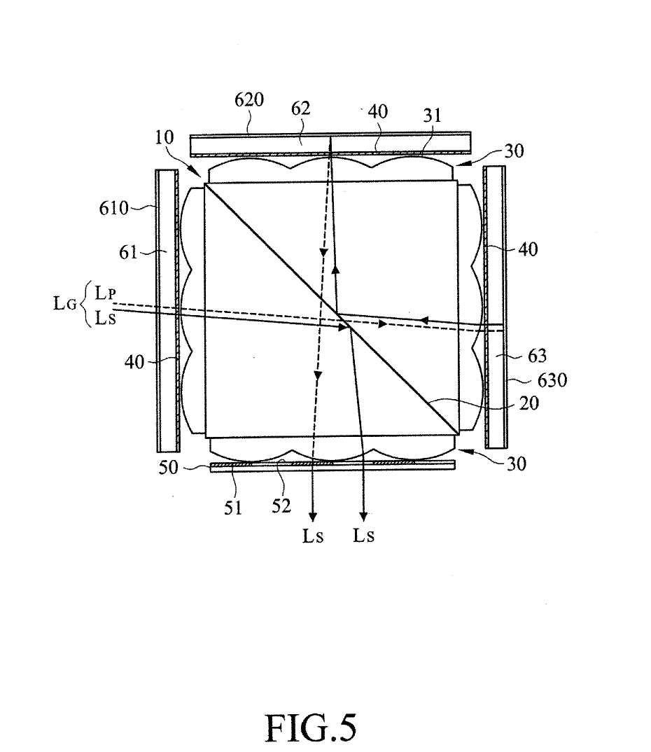

Referring to FIG. 5, a collimated green light L_{G} is incident, with an inclined angle, to an outer side of the optical plate 61(the left-hand side of the drawing sheet) and transmits through the green light transmissive coating 610 to sequentially pass through the optical plate 61, the retarder 40, and the lens array 30 to impinge the polarizing beam splitter 20 of the primary prism 10, wherein the S polarized light L_{S} (solid line) of the green light L_{G} encounters the polarizing beam splitter 20 and is reflected to the outgoing side 101 of the primary prism 10 to emit outward by traveling through the lens array 30. Due to the specific angular arrangement of the inclined incidence, the reflected light L_{S} simply passes through the light transmission zones 52 of the polarization conversion film 50 and still keeps the original polarization, which is S polarized light L_{S}. The P polarized light L_{P} (dotted line) of the green light L_{G} transmits through the polarizing beam splitter 20, passing through the lens array 30 to encounter the right-side retarder 40 and the optical plate 63 located behind, whereby the mirror reflection coating 630 on the outer side of the optical plate 63 reflects the green light and converts, through the characteristics of the retarder 40, the original polarized light into S polarized light L_{S} (solid line) to be directed to the polarizing beam splitter 20 to be reflected thereby in an upward direction to pass through the lens array 30, the retarder 40, and the optical plate 62 at that side and reflected by the coating 620 on the outer side of the optical plate 62 and converted, through the characteristics of the retarder 40, from the original polarized L_{S} light into P polarized light L_{P} (dotted line) to be directed toward and through the polarizing beam splitter 20 and pass through the outgoing side 101 of the primary prism 10 for outward emission through the lens array 30. Due to the specific angular arrangement of the inclined incidence, the transmitting light L_{P} passes through the polarization conversion zones 51 of the polarization conversion film 50 and is converted into S polarized light L_{S}. This allows the original input light including S polarized light L_{S} and P polarized light L_{P} of the green light L_{G} to be finally converted into two S polarized lights L_{S} to emit, in parallel, out of the high efficiency light combination module of projection system according to the present invention.

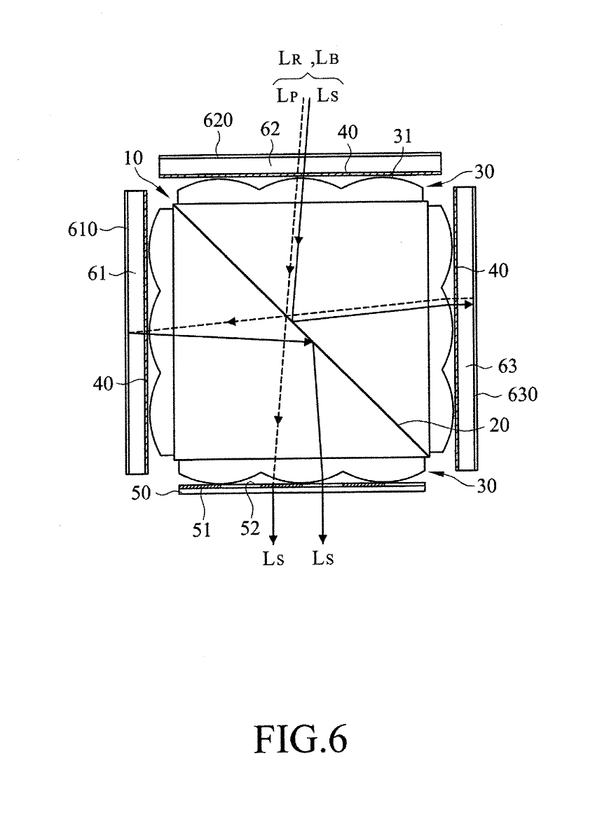

Referring to FIG. 6, collimated red light L_{R} and blue light L_{B} are both incident, with an inclined angle, to an outer side of the optical plate 62 (the top side of the drawing sheet) and transmit through the red and blue light transmissive coating 620 to sequentially pass through the optical plate 62, the retarder 40, and the lens array 30 to impinge the polarizing beam splitter 20 at the center of the primary prism 10, wherein the P polarized lights L_{P} (dotted line) of the red light L_{R} and the blue light L_{B} transmit through the polarizing beam splitter 20 and emit out of the outgoing side 101 of the primary prism 10 to travel through the lens array 30. Due to the specific angular arrangement of the inclined incidence, the transmitting light L_{P} passes through the polarization conversion zones 51 of the polarization conversion film 50 and is converted into S polarized light L_{S}. The S polarized lights L_{S} (solid line) of the red light L_{R} and the blue light L_{B} encounter the polarizing beam splitter 20 and are reflected to the right side to pass through the lens array 30 and encounter the right-side retarder 40 and the optical plate 63 located behind, whereby the coating 630 on the outer side of the optical plate 63 reflect the red and blue lights and converts, through the characteristics of the retarder 40, the original polarized light into P polarized light L (dotted line) to be directed toward and through the polarizing beam splitter 20 to encounter the left-side retarder 40 and the optical plate 61 located behind, whereby the coating 610 at the outer side of the optical plate 61 reflects both of the red and blue lights and converts, through the characteristics of the retarder 40, the original polarized light into S polarized light L_{S} (solid line) to be directed to the polarizing beam splitter 20 and then reflected to the outgoing side 101 of the primary prism 10 to emit outward by passing through the lens array 30. Due to the specific angular arrangement of the inclined incidence, the reflected light L_{S} simply passes through the light transmission zones 52 of the polarization conversion film 50 and still keeps the original polarization, which is S polarized light L_{S}. This allows the original input lights including S polarized lights L_{S} and P polarized lights L_{P} of the red light L_{R} and the blue light L_{B} to be finally converted into two S polarized lights L_{S} to emit, in parallel, out of the high efficiency light combination module of projection system according to the present invention.

In this embodiment, a polarization conversion film 50 is added to have the non-polarized red, blue, and green incident lights L_{R}, L_{B}, L_{G} combined and all converted into S polarized light L_{S}, making it suitable for liquid crystal projection systems.

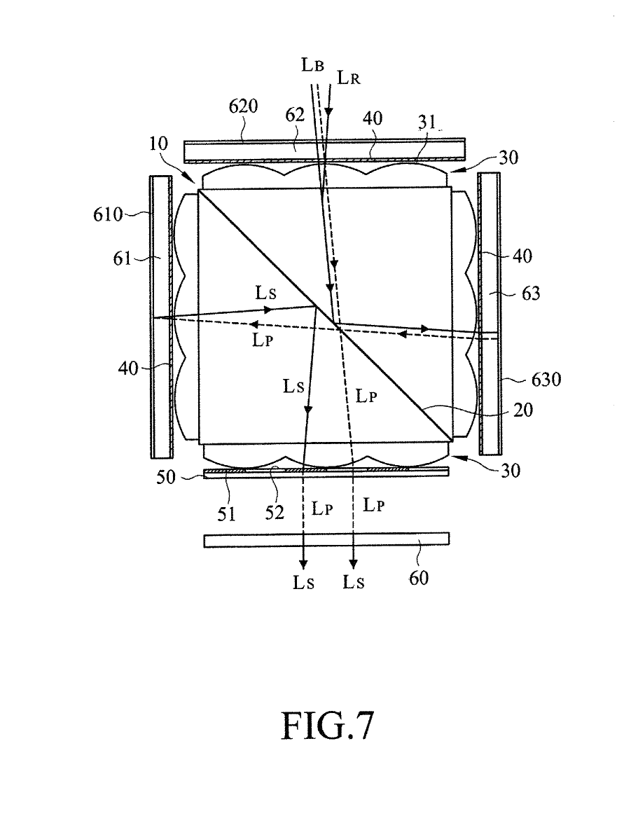

Referring to FIG. 7, collimated blue light L_{B} and red light L_{R} are incident onto the optical plate 62 in directions that are symmetric to the normal on the side surfaces of the optical plate 62(shown as the top side of the drawing sheet). The travel paths of the green light L_{G} and the red light L_{R} are respectively identical to FIGS. 5 and 6, whereby the S polarized lights L_{S} of the green light and the red light pass through the light transmission zones 52 of the polarization conversion film 50 and keep the original polarization, while the P polarized lights L_{P} pass through the polarization conversion zones 51 of the polarization conversion film 50 to convert into S polarized lights L. The blue light L_{B} is exactly opposite. As shown in FIG. 7, due to the incidence angle being symmetric to the red light L_{R}, the P polarized light 4 of the blue light passes through the light transmission zones 52 of the polarization conversion film 50 and keeps the original P state polarization, while the S polarized light L_{S} passes through the polarization conversion zones 51 of the polarization conversion film 50 and convert into P polarized light L_{P}. To have the outgoing lights of all colors showing consistent polarization for projection, the instant embodiment includes a waveband selected phase retarder (for example: ColorSelect™ supplied by Colorlink Ltd.) 60 set at the same side as the polarization conversion film at the outgoing side of the primary prism. The characteristic of the component makes it possible to switch polarization states S and P in specific waveband (or wavebands) without affecting the polarization states of other wavebands (or waveband). The instant embodiment is arranged to convert P polarization of blue light into S polarization, but red and green lights still keep the original S polarization.

In the above description, if the locations of the polarization conversion zones 51 and the light transmission zones 52 of the polarization conversion film 50 are replaced with each other, then the output of polarized light may change from the original S polarized light L_{S} into P polarized light L_{P}. This is dependent on the requirement of polarization for the liquid crystal projection system.

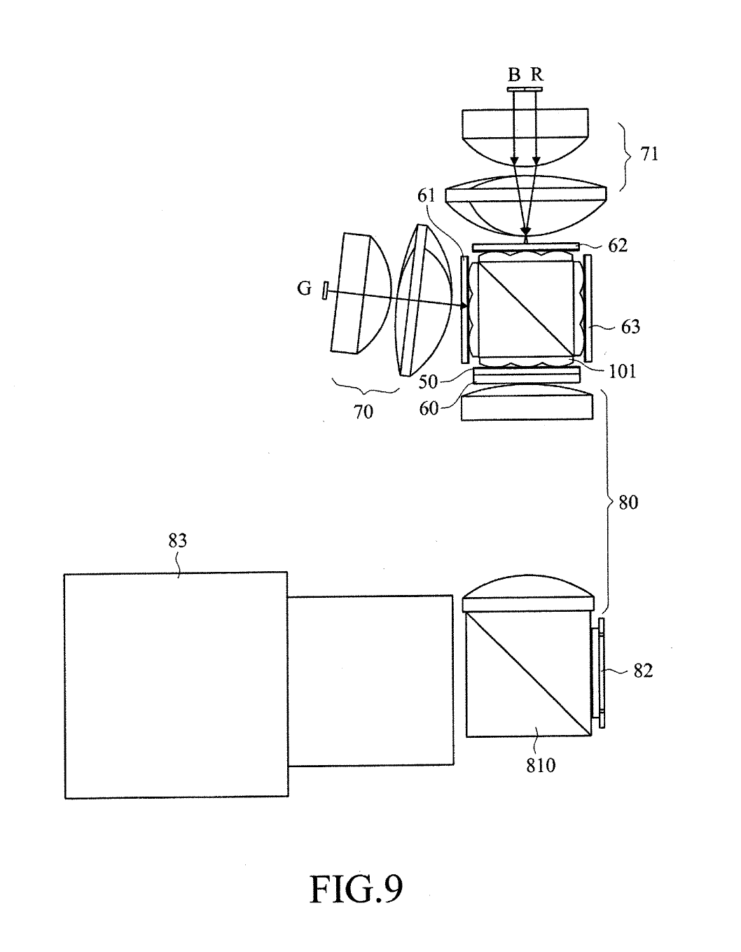

Reference is now made to the disposition of the green light L_{G} in FIG. 5 and the red light L_{R} and the blue light L_{B} in FIG. 7. Referring to FIGS. 2 and 9, a green light collimating lens module 70 is set up at the light incidence port 102 of the primary prism 10 to provide a single color light that is incident at a proper inclination angle onto the optical plate 61. Red and blue light sources are packaged together in a mutually adjacent manner and is combined with a collimating lens module 71 as a dual color light module arranged at the light incidence port 103 so that red light and blue light are incident onto the optical plate 62 in directions that are symmetric to the normal on the side surfaces of the optical plate 62 (the top side of the drawing sheet). Further, a polarization conversion film 50 and waveband selected phase retarder 60 are set at the outgoing side 101 of the primary prism 10 to have the incident lights L_{R}, L_{B}, L_{G} all converted into S polarized lights. Further, a condenser lens set 80 is arranged at the rear side to project the S polarized lights L_{S} of all colors onto a polarizing beam splitter 810 and a liquid crystal reflection panel (i.e. LCOS panel) 82 to allow a projection lens 83 to project out high brightness light that colors and polarizations have been sufficiently combined and converted.

The primary prism of the present invention comprises a diagonally arranged polarizing beam splitter. Such a splitter film is applicable to the entire visible waveband to be operative with optical plate coating film for normal or small angle incidence to form a light combination means. This is contrary to the conventional beam splitter arrangement that might cause cutoff of some waveband due to large angle incidence and polarization shift, so that better combination efficiency can be achieved and improved brightness can be obtained.

Further, the central polarizing beam splitter (PBS) prism of the present invention is easier to be assembled and has simplified coating so as to relatively lower down cost, as compared to the conventional X-cube prism.

The present invention uses lens arrays to achieve the uniformity of the outgoing light beam. Further, in the process of light combination, the range of light beam will not expand during light beam traveling so as to eliminate the problem of volume increase and energy loss.

The present invention is applicable to a liquid crystal projection system to separate and convert P polarized light (L) and S polarized light (L_{S}) of an incident light into a single polarization state of light to enable more efficient for projection.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A high efficiency light combination module of projection system, which at least comprises:
a primary prism, which is a cubic prism having three sides serving as light incidence or light reflection and a remaining side serving as an outgoing side for light projection, a polarizing beam splitting film being set along a diagonal section between two opposite corners of the primary prism;
four lens arrays, each of which comprises a plurality of lens units, the lens arrays being respectively arranged at the sides of the primary prism;
three retarders, which are respectively set at the three sides of the primary prism that serve as light incidence or light reflection to oppose the lens arrays of the three sides to switch P and S polarization states of light; and
three optical plates, which are set outside the three retarders and the lens arrays, each of the three optical plates having one side comprising a coating for transmitting or reflecting specific light.

2. The high efficiency light combination module of projection system according to claim 1, wherein the primary prism is composed of two right-angle prisms and a polarizing beam splitting film sandwiched between hypotenuses of the two right-angle prisms.

3. The high efficiency light combination module of projection system according to claim 1, wherein the primary prism has one side integrally formed with at least one lens array.

4. The high efficiency light combination module of projection system according to claim 1, wherein the coating on the side of one of the optical plates is a mirror reflection coating.

5. The high efficiency light combination module of projection system according to claim 1, wherein the coating of one of the optical plates reflects red and blue lights and transmits green light.

6. The high efficiency light combination module of projection system according to claim 1, wherein the coating of one of the optical plates reflects green light and transmits red and blue lights.

7. The high efficiency light combination module of projection system according to claim 1, wherein a polarization conversion film is set at the light outgoing side of the primary prism to be opposite to the lens array and forms interlaced retarder strips so as to define polarization conversion zones with phase retardation characteristics and non-operative light transmission zones, wherein half-wave phase retardation and orientation of retardation axis of the polarization conversion zones enable polarization switching between two incident polarized lights L_{S}, L_{P}, the polarization conversion zones and the light transmission zones of the polarization conversion film both taking half of the surface area of the lens units of the lens array.

8. The high efficiency light combination module of projection system according to claim 1, wherein a waveband selected phase retarder is arranged at the same side as the polarization conversion film at the outgoing side of the primary prism.
